SEQUENCE LISTING (14 sequences)

SEQ ID NO: 1 - DNA, 50 bp, Artificial Sequence
  Specific target genes from regions of difference in mycobacterium tuberculosis
tcttcgctgatcacctgaccaccggtgagaatggccatatcctgcagcat

SEQ ID NO: 2 - DNA, 50 bp, Artificial Sequence
  Specific target genes from regions of difference in mycobacterium tuberculosis
cgtaaccccagccgaacaacgatgtgtagaactttttggcggcggactga

SEQ ID NO: 3 - DNA, 50 bp, Artificial Sequence
  Specific target genes from regions of difference in mycobacterium tuberculosis
aataccgcctccgtggggtcagcgcactcgtatttcgcgttccaacgaat

SEQ ID NO: 4 - DNA, 50 bp, Artificial Sequence
  Specific target genes from regions of difference in mycobacterium tuberculosis
gcgtcgtcactaagccgcgtagtggtgttgaccatcgccactcacgctag

SEQ ID NO: 5 - DNA, 50 bp, Artificial Sequence
  Specific target genes from regions of difference in mycobacterium tuberculosis
tctgctcggtgcttgggtaggcgctaccgtgtgacagcgcaatgagtgaa

SEQ ID NO: 6 - DNA, 50 bp, Artificial Sequence
  Specific target genes from regions of difference in mycobacterium tuberculosis
tcccctcgtcaaggagggaatgaatggacgtgacatttccctggattgcg

SEQ ID NO: 7 - DNA, 50 bp, Artificial Sequence
  Specific target genes from regions of difference in mycobacterium tuberculosis
tggacgccccaacgatccagttgtcgccgagcgcattcacgaacagcaac

SEQ ID NO: 8 - DNA, 50 bp, Artificial Sequence
  Specific target genes from regions of difference in mycobacterium tuberculosis
agtttggtagtcggggccgaatccaacacgcagcaaccagggaccggtaa

SEQ ID NO: 9 - DNA, 50 bp, Artificial Sequence
  Specific target genes from regions of difference in mycobacterium tuberculosis
gtgccggtcgggtaccgcaatagtgcctgtgccgccatggttttcatagt

SEQ ID NO: 10 - DNA, 50 bp, Artificial Sequence
  Specific target genes from regions of difference in mycobacterium tuberculosis
accacaatctccggggctacgctgacaaacgacatcacacacctccccaa

SEQ ID NO: 11 - DNA, 50 bp, Artificial Sequence
  Specific target genes from regions of difference in mycobacterium tuberculosis
gtgtccaggacttgccgaggtgtggcatccacgtccagataattgatcgt

SEQ ID NO: 12 - DNA, 50 bp, Artificial Sequence
  Specific target genes from regions of difference in mycobacterium tuberculosis
tggtcgaattcggtggagtcgcaaagttgaacgctgaggtcatgtcgcca

SEQ ID NO: 13 - DNA, 50 bp, Artificial Sequence; identical to SEQ ID NO: 12
  Specific target genes from regions of difference in mycobacterium tuberculosis

SEQ ID NO: 14 - DNA, 50 bp, Artificial Sequence
  Specific target genes from regions of difference in mycobacterium tuberculosis
tacaggaagtcccttgccatcctaaaagccaccccacttctctctaagga

(19) United States
(12) Patent Application Publication
(10) Pub. No.: US 2011/0177961 A1
(43) Pub. Date: Jul. 21, 2011

(54) Method of Diagnosing Active Mycobacterium Tuberculosis with Detecting Chip

(75) Inventors: Shiu-Ru Lin, Kaohsiung (TW); Ching-Sheng Yeh, Kaohsiung (TW); Chia-Sui Sun, Kaohsiung (TW); Jong-Rung Tsai, Fongshan (TW); Ming-Je Yang, Taipei (TW)

(73) Assignees: Fooyin University, Kaohsiung County (TW); Institute for Biotechnology and Medicine Industry, Taipei City (TW)

(21) Appl. No.: 12/688,120

(22) Filed: Jan. 15, 2010

(51) Int. Cl. C40B 30/04

(52) U.S. Cl. 506/9

(57) ABSTRACT

The present disclosure diagnoses mycobacterium tuberculosis, not mycobacterium tuberculosis complex only. Specific target genes are selected from regions of difference of mycobacterium tuberculosis. After hybridization with labeling substances, sputum samples are processed through color developments separately for obtaining images to be analyzed automatically. Thus, the present disclosure rapidly diagnoses mycobacterium tuberculosis in the sputum samples with a simple operation and a low cost.

### FIELD OF THE DISCLOSURE

The present disclosure relates to diagnosing mycobacterium tuberculosis; more particularly, relates to directly diagnosing active mycobacterium tuberculosis in sputum samples.

### DESCRIPTION OF THE RELATED ART

Tuberculosis (TB) is an old-age, infectious disease that has spread to nearly every corner of the world. It is a critical issue to alleviate the growing worldwide TB epidemic for public health. The most efficient way of controlling TB lies in early diagnosis and effective TB chemotherapy. At present, clinical symptoms, histopathological features, acid-fast stain, bacillary morphology are mainly the ways of diagnosing TB. Yet, these prior arts are still not effective for diagnosing TB.

Recent biotechnological advance has fuelled a revolution in diagnosing TB, like deoxyribonucleic acid (DNA) probe, polymerase chain reaction (PCR), and PCR-RFLP (restriction fragment length polymorphism). By using a biochip, a fast and accurate diagnosis is obtained with a high performance for early diagnosis and effective disease control. But, these methods are still limited that each genetic marker must be detected separately. In addition, each gene has only one dot on a diagnosing chip so that result of color development of the chip is unstable; and, a false positive or a false negative may be caused owing to human factors on dotting, hybridizing, etc. Moreover, using PCR and PCR-RFLP can only detect presence of mycobacterium tuberculosis complex, not mycobacterium tuberculosis. Accordingly, the above prior arts cost high; and may require expensive equipments while color development is processed. Hence, the prior arts do not fulfill all users' requests on actual use.

### SUMMARY OF THE DISCLOSURE

The main purpose of the present disclosure is to provide a diagnosing chip for directly, rapidly and accurately diagnosing mycobacterium tuberculosis in sputum samples for clinical assistance.

The second purpose of the present disclosure is to select specific target genes from regions of difference in mycobacterium tuberculosis, to extract mRNA from the target genes for hybridization, and to resolve active mycobacterium tuberculosis after the hybridization.

The third purpose of the present disclosure is to diagnose mycobacterium tuberculosis samples with diagnosis procedure regulated and disease propagation controlled.

The fourth purpose of the present disclosure is to build a chip for diagnosing mycobacterium tuberculosis in sputum samples with target genes selected, where diagnosing operation is simple, diagnosing time is saved and diagnosis cost is low

The fifth purpose of the present disclosure is to further measure an expressivity of mRNA as an index to effectiveness of pulmonary tuberculosis chemotherapy.

To achieve the above purposes, the present disclosure is a method of diagnosing active mycobacterium tuberculosis with a detecting chip, comprising steps of: (a) obtaining a tuberculosis (TB) detecting chip, comprising steps of: (a1) obtaining specific target genes from regions of difference in mycobacterium tuberculosis while the target genes have an internal control and the target genes include 14 genes; (a2) obtaining a nylon membrane to be dotted with the target genes and two blank controls to form a triplicate-dotting array; and (a3) obtaining a membrane array on the nylon membrane through cross-linking; (b) obtaining a plurality of sputum samples; (c) obtaining mRNAs in the sputum samples; (d) obtaining cDNAs through reverse transcription to obtain labeling substances as probes; (e) processing the TB detecting chips and the labeling substances through probes labeling, hybridization and post-hybridization separately; (f) processing the TB detecting chips and the labeling substances through color developments separately; and (g) automatically analyzing images obtained after the color developments. Accordingly, a novel method of diagnosing active mycobacterium tuberculosis with a detecting chip is obtained.

### BRIEF DESCRIPTION OF THE DRAWINGS

The present disclosure will be better understood from the following detailed description of the preferred embodiment according to the present disclosure, taken in conjunction with the accompanying drawings, in which

FIG. 1 shows a preferred embodiment according to the present disclosure;

FIG. 2 shows an operation of obtaining the TB detecting chip;

FIG. 3 shows an oligonucleotide sequence table;

FIG. 4 shows a flow diagram of an operation of the preferred embodiment;

FIG. 5 shows a dot arrangement;

FIG. 6 shows the PCR electrophoresis patterns; and

FIG. 7 shows the result of the color development.

### DESCRIPTION OF THE PREFERRED EMBODIMENT

The following description of the preferred embodiment is provided to understand the features and the structures of the present disclosure.

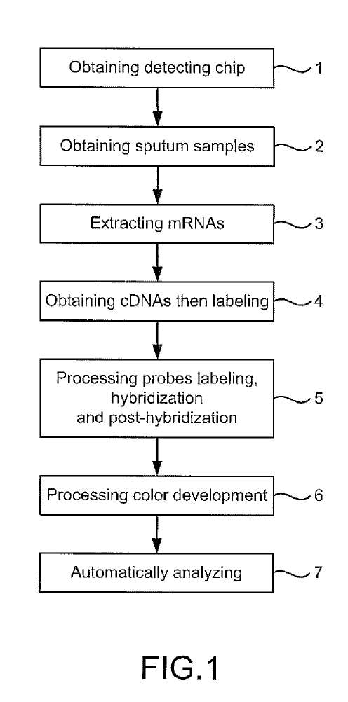

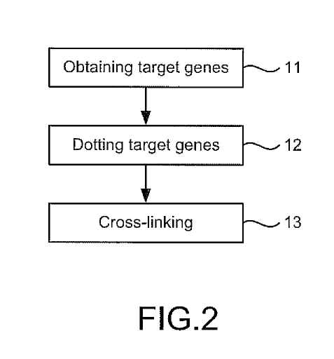

Please refer to FIG. 1 to FIG. 3, which are flow views showing a preferred embodiment according to the present disclosure and an operation of obtaining a TB detecting chip; and a view showing an oligonucleotide sequence table. As shown in the figures, the present disclosure is a method of diagnosing active mycobacterium tuberculosis with a detecting chip, comprising the following steps:

(a) Obtaining detecting chip 1: At first, a tuberculosis (TB) detecting chip is obtained through the following steps:
(a1) Obtaining target genes 11: Specific target genes are selected from regions of difference of mycobacterium tuberculosis. The target genes have 14 genes with an internal control inside.
(a2) Dotting target genes 12: A nylon membrane is obtained. The 14 target genes and two blank controls are dotted on the nylon membrane with an automatic dotting machine to form a triplicate-dotting array.
(a3) Cross-linking 13: A membrane array is obtained on the nylon membrane through cross-linking. Thus, a TB detecting chip is obtained.

(b) Obtaining sputum samples 2: A plurality of sputum samples is obtained.

(c) Extracting mRNAs 3: Messenger ribonucleic acids (mRNA) of the sputum samples are extracted.

(d) Obtaining cDNAs then labeling 4: Complementary deoxyribonucleic acids (cDNA) are obtained through reverse transcription to be labeled for obtaining labeling substances as probes.

(e) Processing probes labeling, hybridization and post-hybridization 5: A plurality of the TB detecting chips is obtained. The TB detecting chips and the labeling substances are processed through probes labeling, hybridization and post-hybridization separately.

(f) Processing color development 6: The TB detecting chips and the labeling substances obtained after hybridization are processed through color developments separately.

(g) Automatically analyzing 7: Images obtained after the color development are analyzed automatically.

Thus, a novel method of diagnosing active mycobacterium tuberculosis with a detecting chip is obtained.

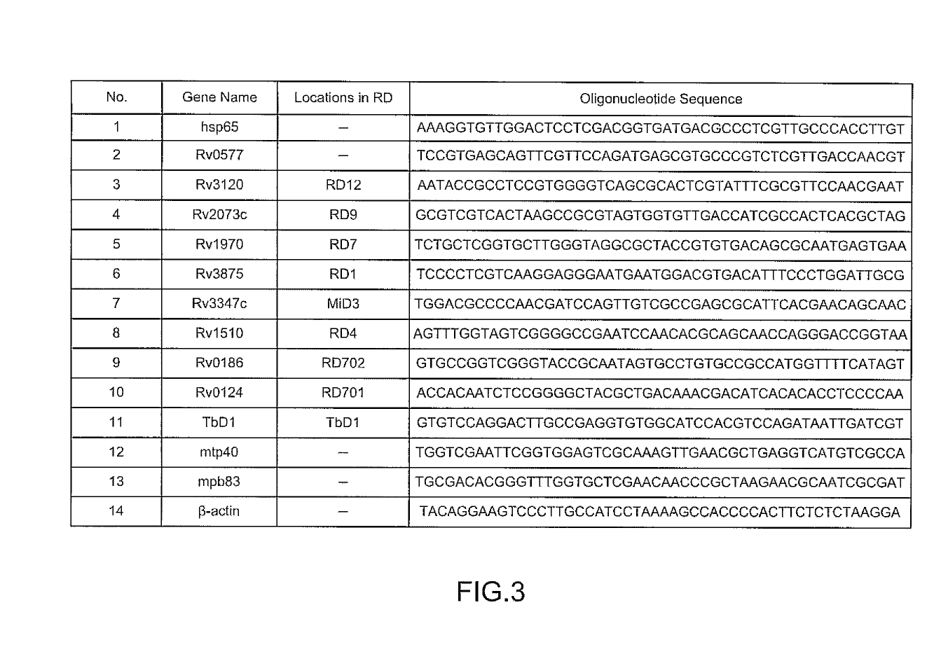

Therein, the 14 target genes of mycobacterium tuberculosis are hsp65, Rv0577, Rv3120, Rv2073c, Rv1970, Rv3875, Rv3347c, Rv1510, Rv0186, Rv0124, TbD1, mtp40, mpb83 and β-actin. An oligonucleotide sequence table of the target genes is shown in FIG. 3, where oligonucleotide sequences of the target genes are obtained through Primer Premier 5.0, PREMIER Giosoft International, Palo Alto, Calif., as follows: oligonucleotide sequence of hsp65 is AAAGGTGTTGGACTCCTCGACGGTGATGAC GCCCTCGTTGCCCACCTTGT; Rv0577, TCCGTGAGCAGTTCGTTCCAGATGAGCGTG CCCGTCTCGTTGACCAACGT; Rv3120, AATACCGCCTCCGTGGGGTCAGCGCACTCG TATTTCGCGTTCCAACGAAT; Rv2073c, GCGTCGTCACTAAGCCGCGTAGTGGTGTTG ACCATCGCCACTCACGCTAG; Rv1970, TCTGCTCGGTGCTTGGGTAGGCGCTACCGT GTGACAGCGCAATGAGTGAA; Rv3875, TCCCCTCGTCAAGGAGGGAATGAATGGACG TGACATTTCCCTGGATTGCG; Rv3347c, TGGACGCCCCAACGATCCAGTTGTCGCCGA GCGCATTCACGAACAGCAAC; Rv1510, AGTTTGGTAGTCGGGGCCGAATCCAACACG CAGCAACCAGGGACCGGTAA; Rv0186, GTGCCGGTCGGGTACCGCAATAGTGCCTGT GCCGCCATGGTTTTCATAGT; Rv0124, ACCACAATCTCCGGGGCTACGCTGACAAAC GACATCACACACCTCCCCAA; TbD1, GTGTCCAGGACTTGCCGAGGTGTGGCATCC ACGTCCAGATAATTGATCGT; mtp40, TGGTCGAATTCGGTGGAGTCGCAAAGTTGA ACGCTGAGGTCATGTCGCCA; mpb83, TGCGACACGGGTTTGGTGCTCGAACAACCCG CTAAGAACGCAATCGCGAT; and β-actin, TACAGGAAGTCCCTTGCCATCCTAAAAGCC ACCCCACTTCTCTCTAAGGA.

Through the above steps, a platform of a chip for diagnosing mycobacterium tuberculosis in sputum samples is obtained, where a diagnosing speed for TB is heightened, a diagnosing time for TB is shortened, TB is detected and typed for early diagnosis and TB is abated. The platform obtained is advantaged in high speed, accuracy, simplicity and low cost for detecting TB in abundant samples. And the platform is used for early diagnosis; and, thus, infection and dissemination of TB are thus guarded.

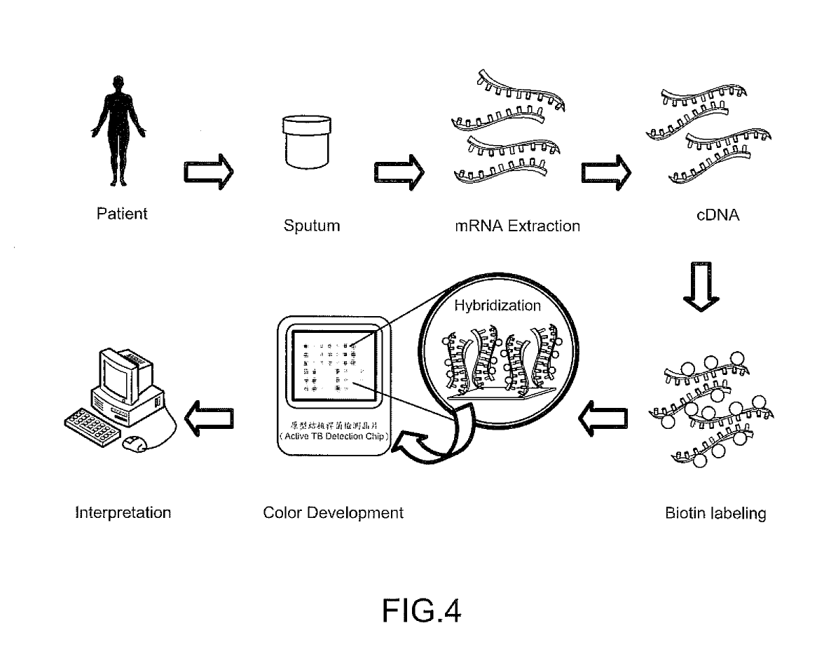

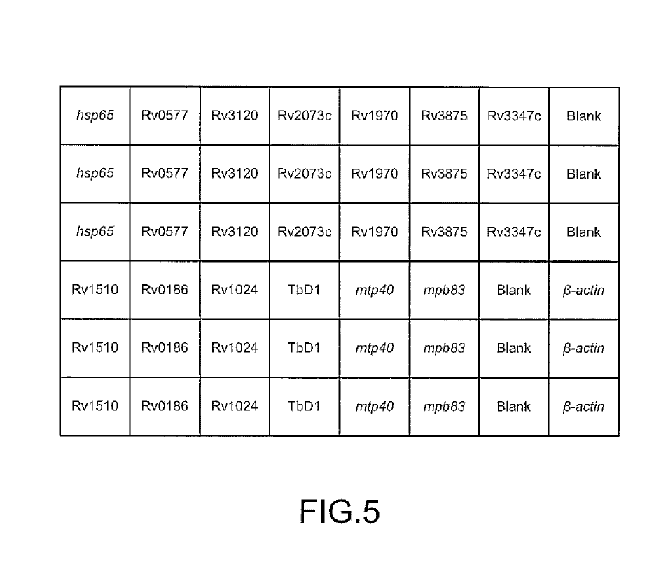

Please refer to FIG. 4 and FIG. 5, which are a flow view showing an operation of the preferred embodiment; and a view showing a dot arrangement. As shown in the figures, 14 specific target genes obtained for the present disclosure are used to directly detect mycobacterium tuberculosis in a sputum sample while only RNA of active mycobacterium tuberculosism is detected to prevent a false positive. β-actin is used as an internal control in the 14 target genes and two of 50% dimethylsulfoxide (DMSO) are used as blank controls, all of which are sunk in a secondary water with a rate of 200 μM. An automatic dotting machine is used to dot the 14 target genes and the two blank controls on a nylon membrane to form a triplicate-dotting array with an interval of 1.5 mm while each dot has a size of 50 nanoliters. Color development stability is confirmed through the triplicate dots for avoiding a false positive or a false negative caused by human factors in dotting process, post-hybridization, etc. As shown in FIG. 5, the triplicate dots of β-actin are located at lower right corner; and the triplicate dots of DMSO are located at lower right corner and lower left corner. A membrane array of the gene dots is obtained through cross-linking with an energy of 1200 joules. Thus, a prototype TB detecting chip is obtained.

A plurality of sputum samples is collected for extracting mRNAs through a refrigerated centrifuge. cDNAs are obtained through reverse transcription in a hybridization oven; and are labeled with Biotin to obtain labeling substances as probes. Then, a plurality of the TB detecting chip with the 14 target genes of the membrane array is obtained. The TB detecting chips and the labeling substances are separately processed through probes labeling at substantially 42° C. for 20 hours (hr) in the hybridization oven with a piece of equipment for labeling digoxigenin (DIG).

Then, the TB detecting chips are sunk in a hybridization solution for 1 hr to 2 hr. Solutions sunk with the TB detecting chips with the DIG labeled are processed through hybridization at 42° C. for 20 hr. After the reactions, color developments are processed, where an anti-DIG antibody having alkaline phosphatase is used for specific binding with NBT (nitroblue tetrazolium)/BCIP (5-bromo-4-chloro-3-indolyl phosphate, toluidinium salt) added. Results of the hybridization are shown through the color developments with the activity of alkaline phosphatase while colors of β-actin are fully developed. A secondary water is then used to stop the reactions and the TB detecting chips are air-dried. In the end, images of the TB detecting chips after the color developments are processed through an automatic analysis and the images are scanned with a scanner to be saved.

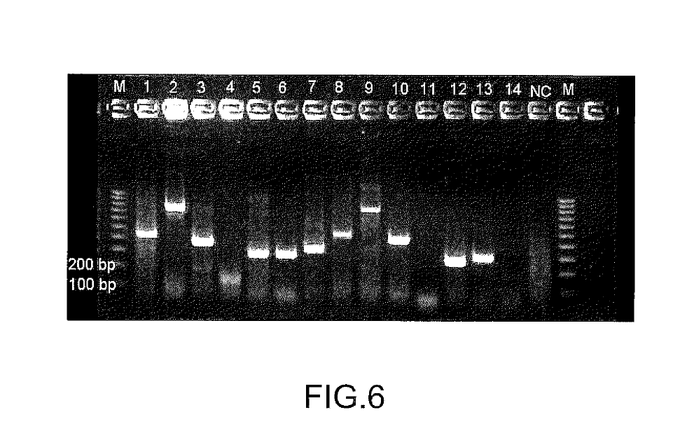

Please refer to FIG. 6, which is a view showing PCR electrophoresis patterns. As shown in the figure, for detecting mycobacterium tuberculosis, not mycobacterium tuberculosis complex only, 14 target genes are used to obtain a view showing electrophoresis patterns obtained after polymerase chain reaction (PCR). Therein, hsp65 of the target genes shown in the view has a section length of 440 bps; Rv0577, 770 bps Rv3120, 371 bps, Rv2073c, 130 bps Rv1970, 288 bps; Rv3875, 287 bps Rv3347c, 331 bps; Rv1510, 454 bps; Rv0186, 762 bps, Rv0124, 421 bps; TbD1, N/A (a missing section in mycobacterium tuberculosis, 426 bps); mtp40, 261 bps; mpb83, 290 bps; and β-actin, 183 bps. As a conclusion, the view showing electrophoresis patterns shows hsp65(+), Rv0577(+), Rv3120(+), Rv2073c(+), Rv1970(+), Rv3875(+), Rv3347c(+), Rv1510(+), Rv0186(+), Rv0124(+), TbD1(−), mtp40(+), mpb83(+) and β-actin(+).

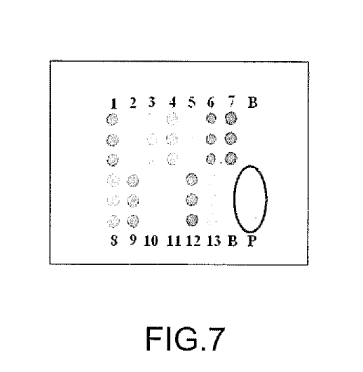

Please refer to FIG. 7, which is a view showing a result of a color development. As shown in the figure, a TB detecting chip obtained with a membrane array of 14 target genes is processed through a color development, and a result is obtained as follows: hsp65(+), Rv0577(+), Rv3120(+), Rv2073c(+), Rv1970(+), Rv3875(+), Rv3347c(+), Rv1510(+), Rv0186(+), Rv0124(+), TbD1(−), mtp40(+), mpb83(+) and β-actin(+).

The result of electrophoresis patterns obtained after PCR as shown in FIG. 6 and the result of the color development as shown in FIG. 7 are compared, and it is found that they match. Hence, it is confirmed that the present disclosure diagnoses mycobacterium tuberculosis.

The present disclosure uses a diagnosing chip to detect active mycobacterium tuberculosis in sputum samples, based on long sequence polymorphism. Target genes in regions of difference are selected for detecting mycobacterium tuberculosis rapidly and sensitively. Besides, oligonucleotide sequences of the target genes are used to examine active mycobacterium tuberculosis through hybridization after extracting mRNAs of the sputum samples. Furthermore, an expressivity of mRNA can be further measured as an index to effectiveness of pulmonary tuberculosis chemotherapy. Thus, the present disclosure detects multiple samples at the same time with characteristics of sensitivity, rapidity and specificity, where target genes are selected to detect sputum samples with a TB diagnosing chip. The present disclosure has an easy operation, a saved time and a low cost. The sputum samples are obtained in a non-invasive way for early diagnosis and propagation control.

To sum up, the present disclosure is a method of diagnosing active mycobacterium tuberculosis with a detecting chip, where a chip for diagnosing active mycobacterium tuberculosis in sputum samples is obtained; and a speed is shortened and a time is save on diagnosing or further typing mycobacterium tuberculosis for early diagnosis and propagation control.

The preferred embodiment herein disclosed is not intended to unnecessarily limit the scope of the disclosure. Therefore, simple modifications or variations belonging to the equivalent of the scope of the claims and the instructions disclosed herein for a patent are all within the scope of the present disclosure.

What is claimed is:

1. A method of diagnosing active mycobacterium tuberculosis with a detecting chip, the method comprising:
(a) obtaining a tuberculosis (TB) detecting chip, comprising steps of:
(a1) obtaining specific target genes from regions of difference in mycobacterium tuberculosis, said target genes comprising 14 genes, said target genes having an internal control;
(a2) obtaining a nylon membrane to be dotted with said target genes and two blank controls to form a triplicate-dotting array; and
(a3) obtaining a membrane array on said nylon membrane through cross-linking;
(b) obtaining a plurality of sputum samples;
(c) obtaining mRNAs in said sputum samples;
(d) obtaining cDNAs through reverse transcription to obtain a plurality of labeling substances as probes;
(e) obtaining a plurality of said TB detecting chips and processing said TB detecting chips and said labeling substances through probes labeling, hybridization and post-hybridization separately;
(f) processing said TB detecting chips and said labeling substances through color developments separately; and
(g) automatically analyzing images obtained after said color developments.

2. The method according to claim 1, wherein, in step (a1), said target genes and said blank controls are sunk in a secondary water with a rate of 200 μM.

3. The method according to claim 1, wherein, in step (a2), said target genes and said blank controls are dotted on said nylon membrane through an automatic dotting machine with an interval of 1.5 mm while each dot has a size of 50 nanoliters.

4. The method according to claim 1, wherein, in step (a3), said cross-linking is processed with an energy of 1200 joules.

5. The method according to claim 1, wherein said internal control is β-actin.

6. The method according to claim 1, wherein each said blank control is dimethylsulfoxide.

7. The method according to claim 1, wherein said probes labeling and said hybridization are processed for 20 hours separately.

8. The method according to claim 1, wherein said probes labeling and said hybridization are processed at substantially 42° C. separately.

9. The method according to claim 1, wherein said 14 genes of said target genes are hsp65, Rv0577, Rv3120, Rv2073c, Rv1970, Rv3875, Rv3347c, Rv1510, Rv0186, Rv0124, TbD1, mtp40, mpb83 and β-actin.

10. The method according to claim 9, wherein said hsp65 has an oligonucleotide sequence of:
A A A G G T G T T G G A C T C C T C G A C G G T G
A T G A C G C C C T C G T T G C C C A C C T T G
T.

11. The method according to claim 9, wherein said Rv0577 has an oligonucleotide sequence of:
T C C G T G A G C A G T T C G T T C C A G A T G A
G C G T G C C C G T C T C G T T G A C C A A C G
T.

12. The method according to claim 9, wherein said Rv3120 has an oligonucleotide sequence of:
A A T A C C G C C T C C G T G G G G T C A G C G C
A C T C G T A T T T C G C G T T C C A A C G A A
T.

13. The method according to claim 9, wherein said Rv2073c has an oligonucleotide sequence of:
G C G T C G T C A C T A A G C C G C G T A G T G G
T G T T G A C C A T C G C C A C T C A C G C T A
G.

14. The method according to claim 9, wherein said Rv1970 has an oligonucleotide sequence of:
T C T G C T C G G T G C T T G G G T A G G C G C T
A C C G T G T G A C A G C G C A A T G A G T G A
A.

15. The method according to claim 9, wherein said Rv3875 has an oligonucleotide sequence of:
T C C C C T C G T C A A G G A G G G A A T G A A T
G G A C G T G A C A T T T C C C T G G A T T G C
G.

16. The method according to claim 9, wherein said Rv3347c has an oligonucleotide sequence of:
T G G A C G C C C C A A C G A T C C A G T T G T C
G C C G A G C G C A T T C A C G A A C A G C A A
C.

17. The method according to claim 9, wherein said Rv1510 has an oligonucleotide sequence of:
A G T T T G G T A G T C G G G G C C G A A T C C A
A C A C G C A G C A A C C A G G G A C C G G T A
A.

18. The method according to claim 9, wherein said Rv0186 has an oligonucleotide sequence of:
G T G C C G G T C G G G T A C C G C A A T A G T G
C C T G T G C C G C C A T G G T T T T C A T A G
T.

19. The method according to claim 9, wherein said Rv0124 has an oligonucleotide sequence of:
A C C A C A A T C T C C G G G G C T A C G C T G A
C A A A C G A C A T C A C A C A C C T C C C C A
A.

20. The method according to claim 9, wherein said TbD1 has an oligonucleotide sequence of:
G T G T C C A G G A C T T G C C G A G G T G T G G
C A T C C A C G T C C A G A T A A T T G A T C G
T.

21. The method according to claim 9, wherein said mtp40 has an oligonucleotide sequence of:
T G G T C G A A T T C G G T G G A G T C G C A A A
G T T G A A C G C T G A G G T C A T G T C G C C
A.

22. The method according to claim 9, wherein said mpb83 has an oligonucleotide sequence of:
T G C G A C A C G G G T T T G G T G C T C G A A C
A A C C C G C T A A G A A C G C A A T C G C G A
T.

23. The method according to claim 9, wherein said 13-actin has an oligonucleotide sequence of:
T A C A G G A A G T C C C T T G C C A T C C T A A
A A G C C A C C C C A C T T C T C T C T A A G G
A.
